(19) United States
(12) Patent Application Publication
(10) Pub. No.: US 2019/0157776 A1
(43) Pub. Date: May 23, 2019

(54) PASS-THROUGH CABLE CONNECTOR ASSEMBLY AND METHOD OF MAKING THE SAME

(71) Applicant: DELPHI TECHNOLOGIES IP LIMITED, ST. MICHAEL (BB)

(72) Inventors: Jesus J. Castillo, Chihuahua (MX); Alma L. Leanos, Chihuahua (MX); Flavio M. Ono, Chihuahua (MX); David C. Estrada, El Paso, TX (US)

(21) Appl. No.: 15/821,060

(22) Filed: Nov. 22, 2017

(51) Int. Cl. H01R 4/70; H01R 4/26; H01R 43/20; H01R 43/00; H02G 15/013; H02G 15/08; H01B 17/30

(52) U.S. Cl. CPC H01R 4/70; H01R 4/26; H01R 43/20; H01B 17/303; H02G 15/013; H02G 15/08; H01R 43/005

(57) ABSTRACT

A pass-through cable connector assembly includes a connector body extending along an axis and having a peripheral wall which surrounds the axis and defines an interior of the connector body, the connector body also having a compartment wall which divides the interior into first and second compartment, the compartment wall having an aperture extending therethrough from the first compartment to the second compartment, the aperture defining an aperture wall. A first cable is located within the first compartment. A first terminal in electrical communication with the first cable is located within the aperture and circumferentially contacts the aperture wall. A second cable in electrical communication with the second cable is located within the second compartment. The first terminal and the second terminal have complementary mating features which mechanically lock the first terminal to the second terminal and place the first terminal in electrical communication with the second terminal.

### TECHNICAL FIELD OF INVENTION

The present invention relates to a pass-through cable connector assembly which provides electrical communication between a first environment and a second environment while sealing the first environment from the second environment. The present invention also provides a method of making the pass-through cable connector assembly.

### BACKGROUND OF INVENTION

It is known to use a pass-through cable connector assembly to transmit electricity between two distinct environments, for example between Earth's atmosphere and the interior of a fuel tank which supplies liquid fuel such as gasoline to an internal combustion engine. The pass-through cable connector assembly includes one or more cables which extend through a connector body such that the connector body circumferentially engages each cable in order to prevent intermixing of the two distinct environments. The cables may each include wires comprising individual strands which are covered by electrical insulation. The individual strands may provide a leak path between the two environments. In order to eliminate the individual strands from forming a leak path, a portion of electrical insulation may be stripped and solder is applied to the stripped portion. The solder wicks into the strands, thereby eliminating the leak path. The stripped portion which has had solder applied is then placed within the connector body. Subsequently, the connector body is filled with epoxy in order to electrically isolate the stripped portion of wire and to seal between the wire and the connector body. However, maintaining the position of the cables within the connector body may be difficult when applying the epoxy. In another arrangement shown in U.S. Pat. No. 6,501,025 solves the issue of the strands providing a leak path by splicing cables with a connector. The wire splices are then embedded within the connector body by forming the connector body in an overmolding operation. However, maintaining the position of the cables is still difficult and all of the cables must be located along a parting line of the mold used to form the connector body. Since all of the cables must be located along a parting line of the mold, the size of the connector body may increase significantly when more than two cables are provided.

What is needed is a pass-through cable connector assembly which minimizes or eliminates one or more of the shortcomings as set forth above.

### SUMMARY OF THE INVENTION

Briefly described, a pass-through cable connector assembly includes a connector body extending along an axis and formed of an electrically insulating material, the connector body having a peripheral wall which surrounds the axis and defines an interior of the connector body, the connector body also having a compartment wall which divides the interior into a first compartment and a second compartment, the compartment wall having an aperture extending therethrough from the first compartment to the second compartment, the aperture defining an aperture wall; a first cable comprising an inner core made of an electrically conductive material, the first cable being located within the first compartment; a first terminal formed of an electrically conductive material, the first terminal being located within the aperture and circumferentially contacting the aperture wall, the first terminal being joined to the inner core of the first cable such that the first terminal is in electrical communication with the inner core of the first cable; a second cable comprising an inner core made of an electrically conductive material, the second cable being located within the second compartment; and a second terminal formed of an electrically conductive material, the second terminal being joined to the inner core of the second cable such that the second terminal is in electrical communication with the inner core of the second cable; wherein the first terminal and the second terminal have complementary mating features which mechanically lock the first terminal to the second terminal and which place the first terminal in electrical communication with the second terminal.

A method of making a pass-through cable connector assembly includes providing a connector body which extends along an axis and is formed of an electrically insulating material, the connector body having a peripheral wall which surrounds the axis and defines an interior of the connector body, the connector body also having a compartment wall which divides the interior into a first compartment and a second compartment, the compartment wall having an aperture extending therethrough from the first compartment to the second compartment, the aperture defining an aperture wall; providing a first cable comprising an inner core made of an electrically conductive material, the inner core of the first cable being joined to a first terminal made of an electrically conductive material such that the first terminal is in electrical communication with the inner core of the first cable; positioning the first terminal within the aperture such that the first terminal circumferentially contacts the aperture wall and such that the first cable is located within the first compartment; providing a second cable comprising an inner core made of an electrically conductive material, the inner core of the second cable being joined to a second terminal made of an electrically conductive material such that the second terminal is in electrical communication with the inner core of the second cable; and joining the second terminal with the first terminal using complementary mating features which mechanically lock the first terminal to the second terminal and which place the first terminal in electrical communication with the second terminal, wherein the step of joining positions the second cable within the second compartment.

### BRIEF DESCRIPTION OF DRAWINGS

This invention will be further described with reference to the accompanying drawings in which:

FIG. 1 is a cross-sectional view of a pass-through cable connector assembly in accordance with the present invention;

FIG. 2 is and isometric, partial exploded view of the pass-through cable connector assembly;

FIG. 3 is a cross-sectional view of a connector body of the pass-through cable connector assembly;

FIG. 4 is a plan view looking into a first compartment of the connector body;

FIG. 5 is an isometric view of a first cable of the pass-through cable connector assembly;

FIG. 6 is an isometric view of a second cable of the pass-through cable connector assembly;

FIG. 7 is a cross-sectional view of a first terminal of the pass-through cable connector assembly;

FIG. 8 is a cross-sectional view of a second terminal of the pass-through cable connector assembly; and

FIG. 9 shows a method of assembling the pass-through cable connector assembly.

### DETAILED DESCRIPTION OF INVENTION

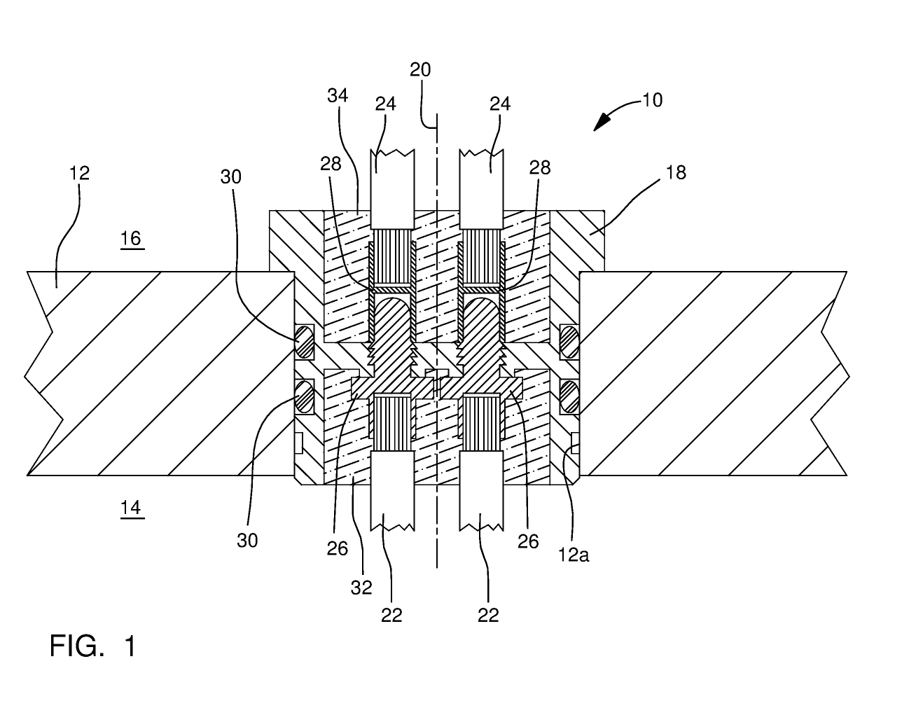

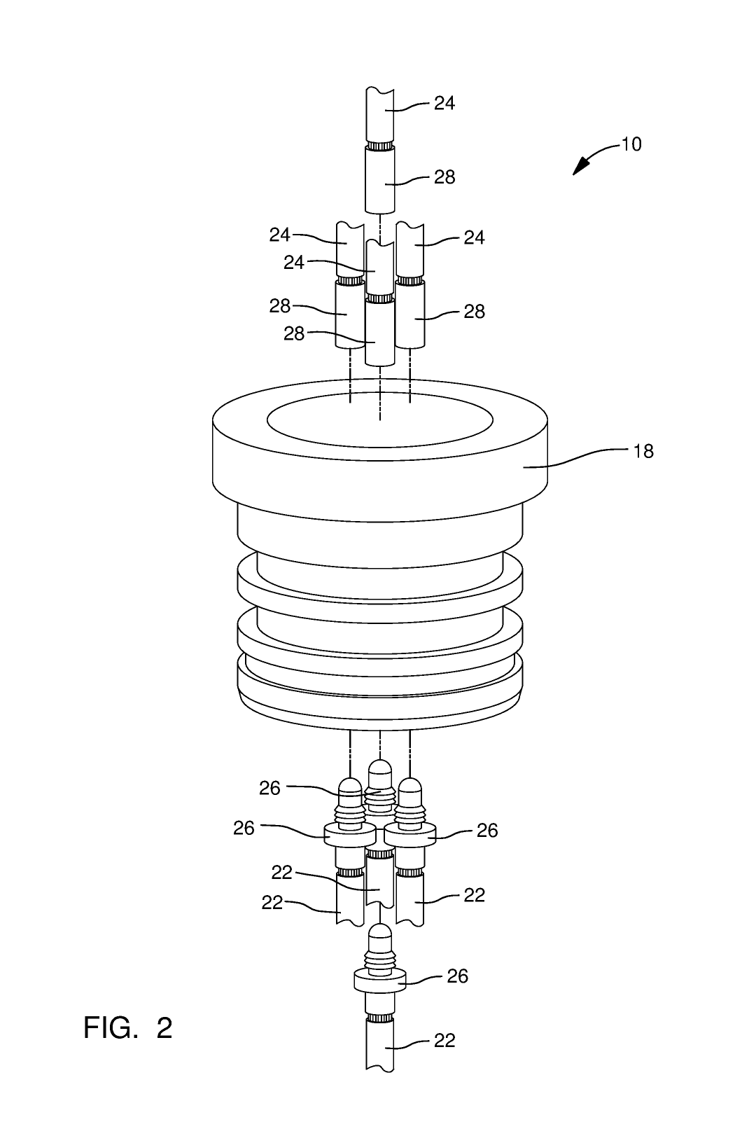

Referring initially to FIGS. 1 and 2, a pass-through cable connector assembly 10 in accordance with the present invention is shown. A partition 12 segregates a first environment 14 from a second environment 16 such that partition 12 includes a partition aperture 12a extending therethrough within which pass-through cable connector assembly 10 is located. Pass-through cable connector assembly 10 provides for electrical communication between first environment 14 and second environment 16 while providing a hermitic seal between first environment 14 and second environment 16. By way of non-limiting example only, first environment 14 may the interior of a fuel tank and second environment 16 may be Earth's atmosphere where pass-through cable connector assembly 10 provides for electrical communication between a power source (not shown) and a controller (not shown) located within second environment 16 and a fuel pump (not shown) and a fuel level sensor (not shown) located within first environment 14. Consequently, in the exemplified usage, pass-through cable connector assembly 10 prevents fuel and fuel vapor from passing from the interior of the fuel tank to the atmosphere and also prevents water, dirt, and other contaminants from passing from the atmosphere to the interior of the fuel tank.

Pass-through cable connector assembly 10 includes a connector body 18 extending along, and centered about an axis 20; a first plurality of cables 22 (hereinafter first cables 22) located on the side of pass-through cable connector assembly 10 which is exposed to first environment 14; a second plurality of cables 24 (hereinafter second cables 24) located on the side of pass-through cable connector assembly 10 which is exposed to second environment 16; a first plurality of terminals 26 (hereinafter first terminals 26) such that each first terminal 26 are associated with a respective first cable 22; and a second plurality of terminals 28 (hereinafter second terminals 28) such that each second terminal 28 is associated with a respective second cable 24. While pass-through cable connector assembly 10 has been illustrated as having four of each of first cables 22, second cables 24, first terminals 26 and second terminals 28, it should be understood that a greater or lesser quantity may be provided depending on the number of conductors that are necessary to provide electrical communication between first environment 14 and second environment 16. In the paragraphs that follow, the individual elements of pass-through cable connector assembly 10 will be described in greater detail.

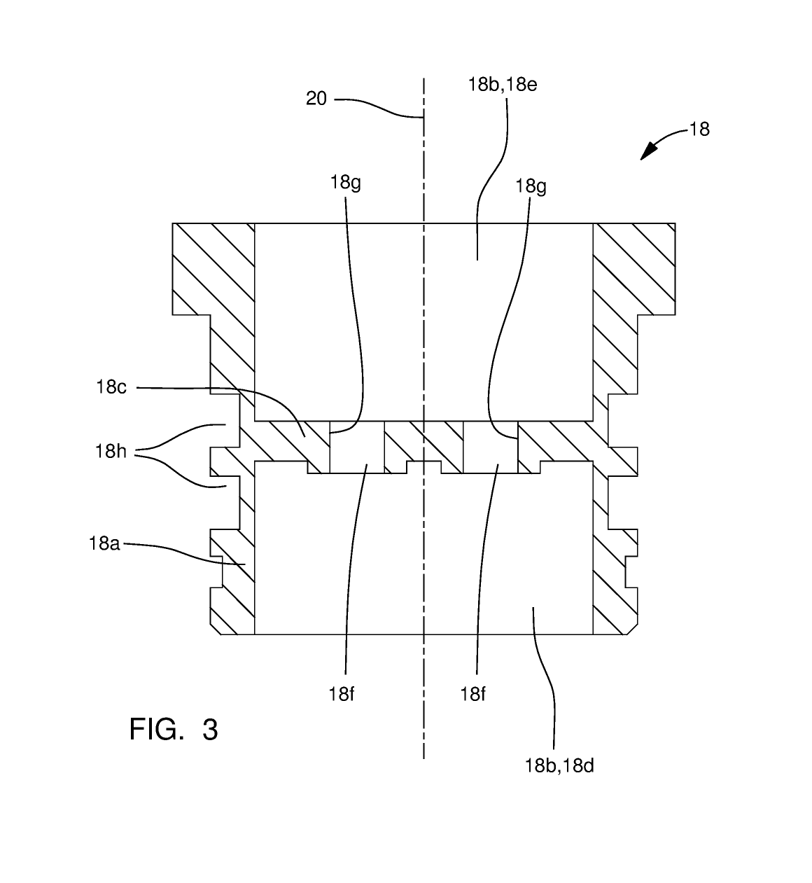

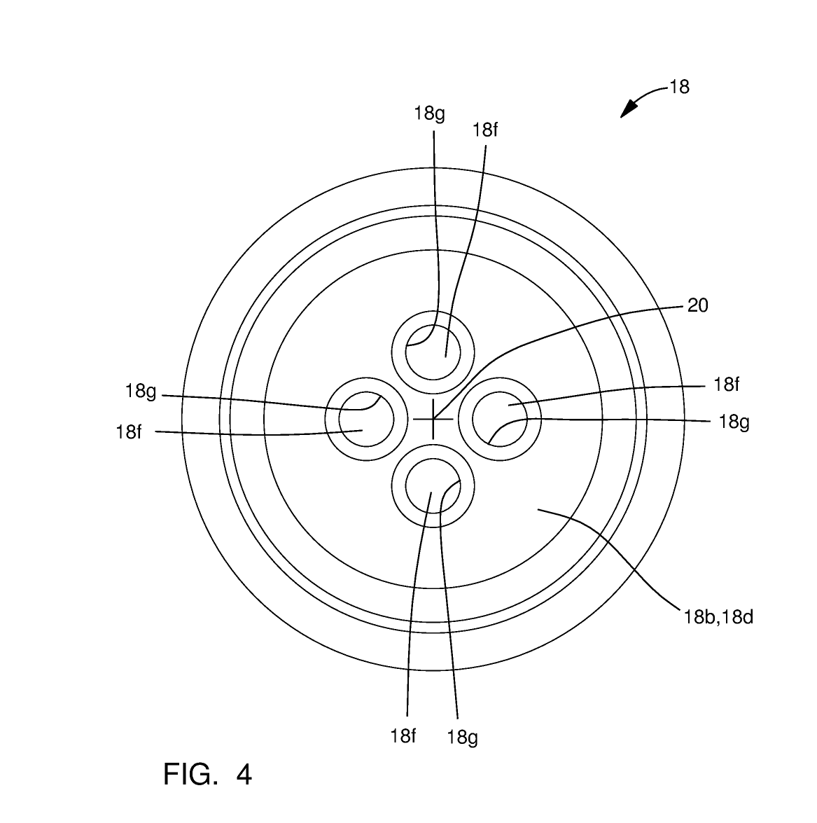

With continued reference to FIGS. 1 and 2 and now with additional reference to FIGS. 3 and 4, connector body 18 is formed of an electrically insulating material and includes a peripheral wall 18a which surrounds, and is centered about axis 20 where the cross-sectional shape of peripheral wall 18a taken perpendicular to axis 20 is an annulus. While peripheral wall 18a is illustrated as having a cross-sectional shape of a circular annulus, it should be understood that the annulus may alternatively be square, rectangular, or any other regular or irregular shape. The annular nature of peripheral wall 18a defines an interior 18b within peripheral wall 18a. Connector body 18 also includes a compartment wall 18c which traverses interior 18b, thereby dividing interior 18b into a first compartment 18d which faces toward first environment 14 and a second compartment 18e which faces toward second environment 16. A plurality of apertures 18f extend through compartment wall 18c from first compartment 18d to second compartment 18e such that each aperture 18f defines an aperture wall 18g which is a closed figure, and in the embodied configuration of the figures, aperture wall 18g is a cylindrical surface. As best seen in FIG. 4, apertures 18f may be arranged in a pattern such that all apertures 18f need not be in a linear arrangement with each other as is necessary in prior art arrangements which use overmolding, thus requiring all terminals to be in a linear arrangement along a parting line of a mold. In this way, pass-through cable connector assembly 10 can accommodate more first cables 22 and second cables 24 per cross-sectional area (i.e. perpendicular to axis 20) than prior art arrangements which utilize overmolding. The outer periphery of peripheral wall 18a may include one or more grooves 18h which are annular in shape and which are centered about and surround axis 20. Each groove 18h receives a complementary O-ring 30 which is circumferentially compressed between connector body 18 and partition 12 within partition aperture 12a, thereby sealing the interface between partition 12 and pass-through cable connector assembly 10. Connector body 18 may be made, by way of non-limiting example only, with an injection molding process which injects melted plastic into a mold (not shown) where the melted plastic is allowed to cool and solidify within the mold before being removed. In this way, the features of connector body 18 described herein may be formed efficiently and economically in a single operation as a single piece of plastic.

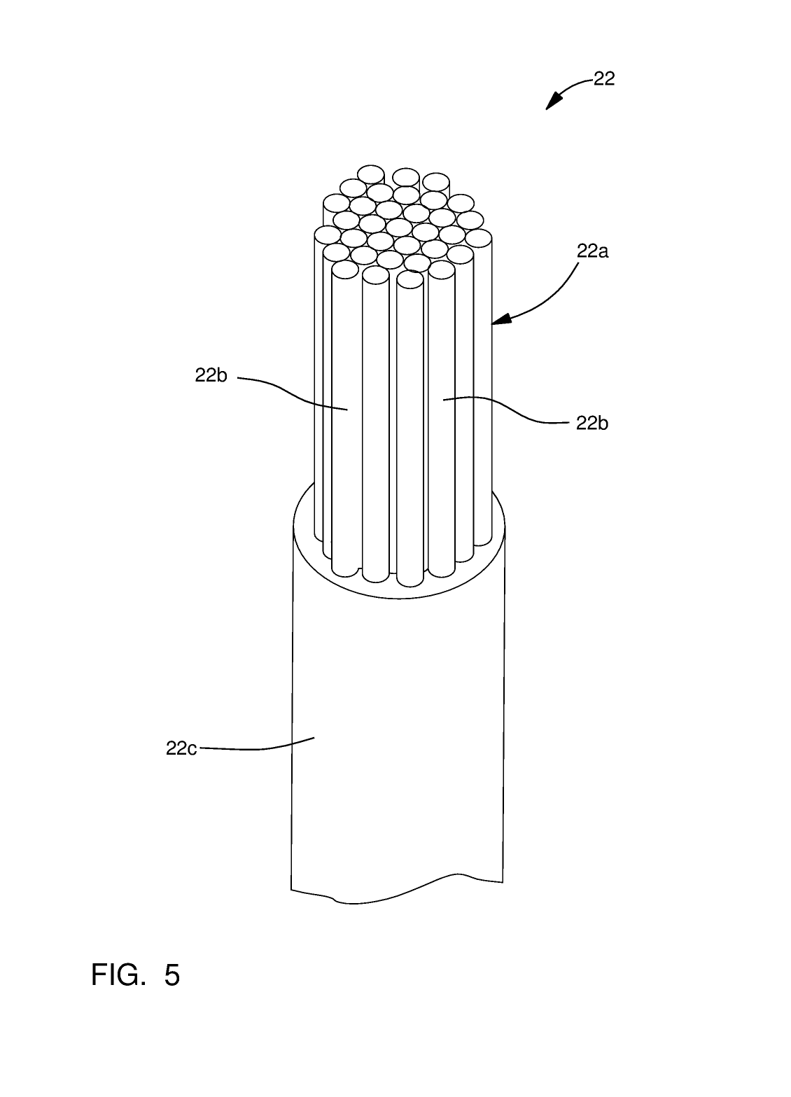

With continued reference to FIGS. 1 and 2 and now with additional reference to FIG. 5, first cables 22 may all be substantially the same, and consequently, the description provide hereafter will be in singular form with the understanding that the description applies to each first cable 22. First cable 22 includes an inner core 22a made of an electrically conductive material, which may be, by way of non-limiting example only, copper, aluminum, or alloys comprising one or more of copper and aluminum. Furthermore, inner core 22a may be made of a plurality of individual wire strands 22b. First cable 22 also includes an electrically insulating covering 22c which surrounds inner core 22a. By way of non-limiting example only, electrically insulating covering 22c may be polytetrafluorethylene (PTFE) or any other material commonly used for insulating electricity conducting wires and cables. A portion of electrically insulating covering 22c is stripped away from inner core 22a in order to facilitate electrical communication between inner core 22a and first terminal 26.

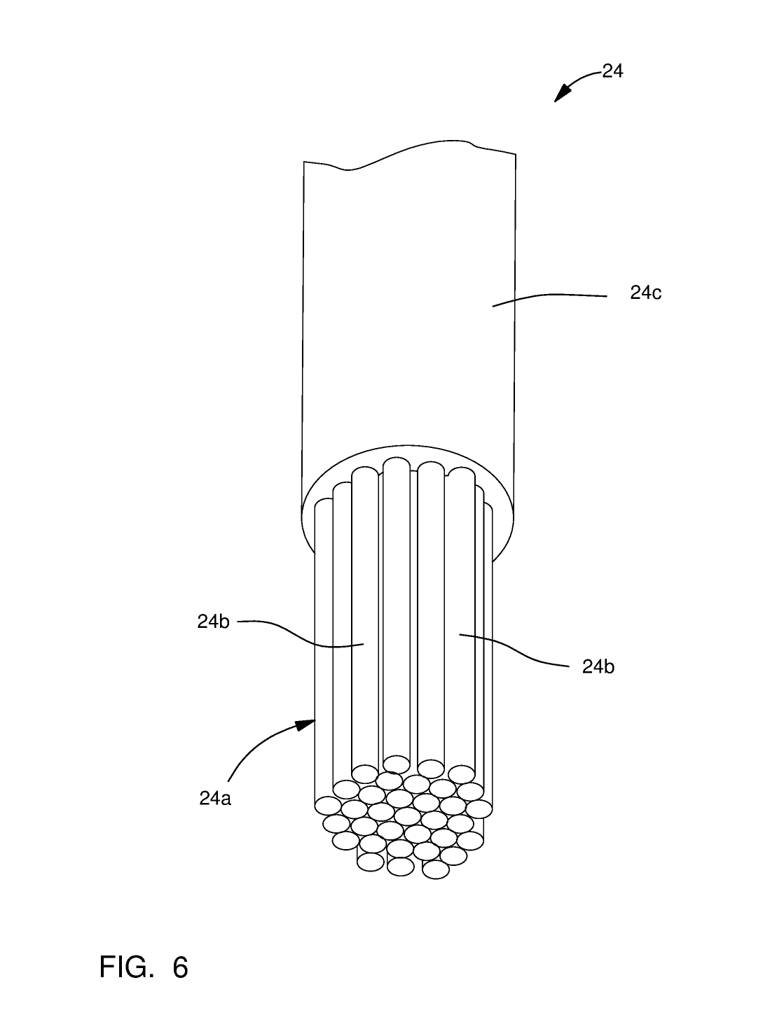

With continued reference to FIGS. 1 and 2 and now with additional reference to FIG. 6, second cables 24 may all be substantially the same, and consequently, the description provide hereafter will be in singular form with the understanding that the description applies to each second cable 24. Second cable 24 includes an inner core 24a made of an electrically conductive material, which may be, by way of non-limiting example only, copper, aluminum, or alloys comprising one or more of copper and aluminum. Furthermore, inner core 24a may be made of a plurality of individual wire strands 24b. Second cable 24 also includes an electrically insulating covering 24c which surrounds inner core 24a. By way of non-limiting example only, electrically insulating covering 24c may be polytetrafluorethylene (PTFE) or any other material commonly used for insulating electricity conducting wires and cables. A portion of electrically insulating covering 24c is stripped away from inner core 24a in order to facilitate electrical communication between inner core 24a and second terminal 28.

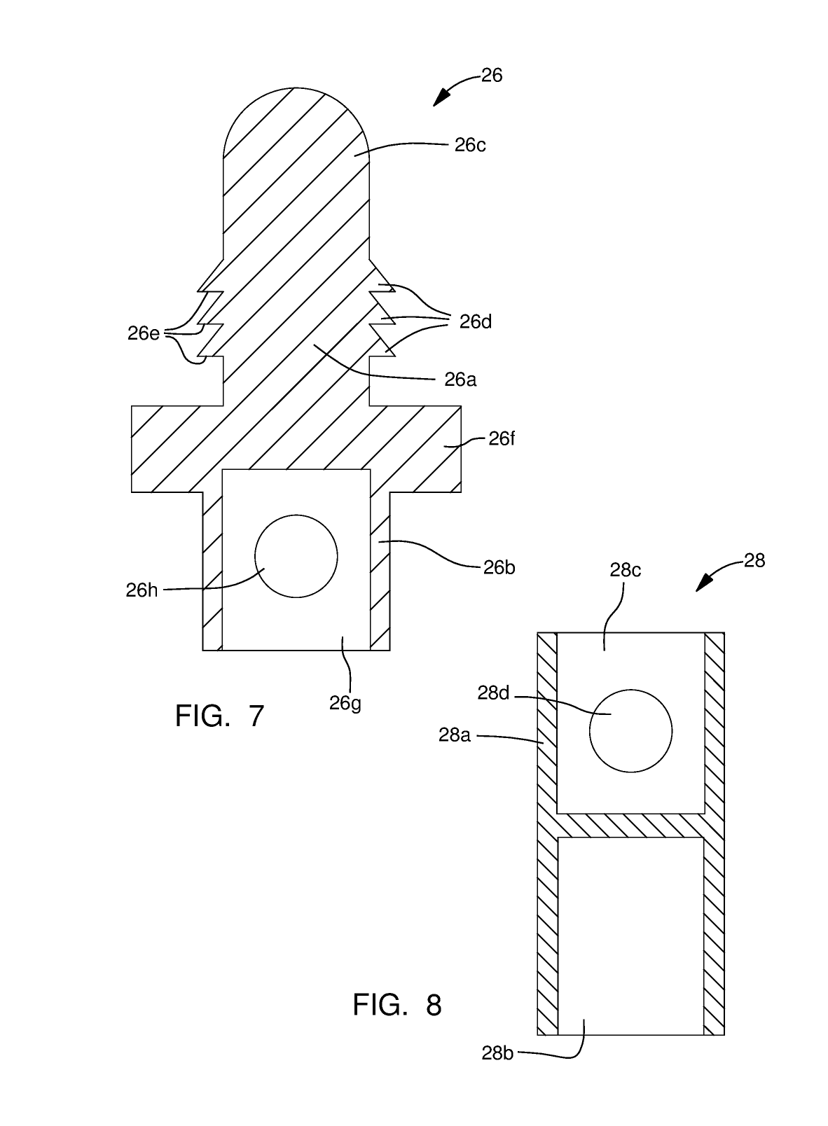

With continued reference to FIGS. 1 and 2 and now with additional reference to FIG. 7, first terminals 26 may all be substantially the same, and consequently, the description provide hereafter will be in singular form with the understanding that the description applies to each first terminal 26. First terminal 26 is formed of an electrically conductive material, which is preferably a metallic material. First terminal 26 includes a central portion 26a which is located between a cable-mating portion 26b and a complementary mating feature 26c. As illustrated herein, complementary mating feature 26c is a male mating feature, however, may alternatively be a female mating feature. Central portion 26a is located within aperture 18f of connector body 18 such that central portion 26a is complementary to aperture wall 18g. In this way, central portion 26a circumferentially contacts aperture wall 18g in order to seal the interface between first terminal 26 and aperture wall 18g. In order to promote and enhance sealing between first terminal 26 and aperture wall 18g, central portion 26a includes one or more barbs 26d which extend circumferentially outward from central portion 26a. As shown herein, each barb 26d progressively extends further outward from central portion 26a when moving in a direction from complementary mating feature 26c to cable-mating portion 26b and terminates in a barb shoulder 26e which may extend perpendicular to axis 20. When first terminal 26 is inserted into aperture 18f, barbs 26d plastically deform aperture wall 18g causing aperture wall 18g to flow around barbs 26d, thereby creating a tortuous interface between first terminal 26 and aperture wall 18g which prevents communication between first environment 14 and second environment 16. A first terminal flange 26f extends circumferentially outward where central portion 26a meets cable-mating portion 26b such that first terminal flange 26f is larger than aperture 18f. In this way, first terminal flange 26f abuts compartment wall 18c to limit the extent to which first terminal 26 is inserted into aperture 18f. First terminal flange 26f is also larger than cable-mating portion 26b, in a direction perpendicular to axis 20, and in this way, first terminal flange 26f acts as a feature on which to apply force for inserting first terminal 26 into aperture 18f. Cable-mating portion 26b includes features for mating and fixing to the stripped portion of inner core 22a in order to provide electrical communication between first terminal 26 and inner core 22a. As illustrated herein, cable-mating portion 26b is located within first compartment 18d and includes a bore 26g which receives the stripped portion of inner core 22a therein. Inner core 22a may be fixed within bore 26g, by way of non-limiting example only, with crimping, a solder connection, a weld connection, or combinations thereof. In order to eliminate first cable 22 itself from being a leak path, cable-mating portion 26b includes a transverse bore 26h which extends perpendicular to axis 20 and intersects with bore 26g. In this way, solder may be applied to inner core 22a through transverse bore 26h such that the solder is wicked by wire strands 22b to eliminate the possibility of a leak path through first cable 22.

With continued reference to FIGS. 1 and 2 and now with additional reference to FIG. 8, second terminals 28 may all be substantially the same, and consequently, the description provide hereafter will be in singular form with the understanding that the description applies to each second terminal 28. Second terminal 28 is formed of an electrically conductive material, which is preferably a metallic material. Second terminal 28 includes a cable-mating portion 28a and a complementary mating feature 28b. As illustrated herein, second terminal 28 is located entirely within second compartment 18e. Also as illustrated herein, complementary mating feature 28b is a female mating feature which complements complementary mating feature 26c of first terminal 26 and which interfaces with complementary mating feature 26c in an friction or interference fit relationship, thereby retaining first terminal 26 and second terminal 28 together. While complementary mating feature 28b has been illustrated as a female mating feature, it should be understood that complementary mating feature 28b may alternatively be a male mating feature if complementary mating feature 26c of first terminal 26 is a female mating feature. Cable-mating portion 28a includes features for mating and fixing to the stripped portion of inner core 24a in order to provide electrical communication between second terminal 28 and inner core 24a. As illustrated herein, cable-mating portion 28a includes a bore 28c which receives the stripped portion of inner core 24a therein. Inner core 24a may be fixed within bore 28c, by way of non-limiting example only, with crimping, a solder connection, a weld connection, or combinations thereof. In order to eliminate second cable 24 itself from being a leak path, cable-mating portion 28a includes a transverse bore 28d which extends perpendicular to axis 20 and intersects with bore 28c. In this way, solder may be applied to inner core 24a through transverse bore 28d such that the solder is wicked by wire strands 24b to eliminate the possibility of a leak path through second cable 24.

In order to further ensure that pass-through cable connector assembly 10 provides a seal between first environment 14 and second environment 16, first compartment 18d may include a first potting material 32 which circumferentially engages peripheral wall 18a and encapsulates first terminals 26 within first compartment 18d. Furthermore, first potting material 32 circumferentially engages each first cable 22, and preferably, first compartment 18d is sufficiently filled so as to allow first potting material 32 to circumferentially engage covering 22c of each first cable 22. First potting material 32 may be, by way of non-limiting example only, an epoxy material, the specific composition of which may be selected to be compatible with the environment to which it will be exposed. Similarly, in order to further ensure that pass-through cable connector assembly 10 provides a seal between first environment 14 and second environment 16, second compartment 18e may include a second potting material 34 which circumferentially engages peripheral wall 18a and encapsulates second terminals 28 within second compartment 18e. Furthermore, second potting material 34 circumferentially engages each second cable 24, and preferably, second compartment 18e is sufficiently filled so as to allow second potting material 34 to circumferentially engage covering 24c of each second cable 24. Second potting material 34 may be, by way of non-limiting example only, an epoxy material, the specific composition of which may be selected to be compatible with the environment to which it will be exposed.

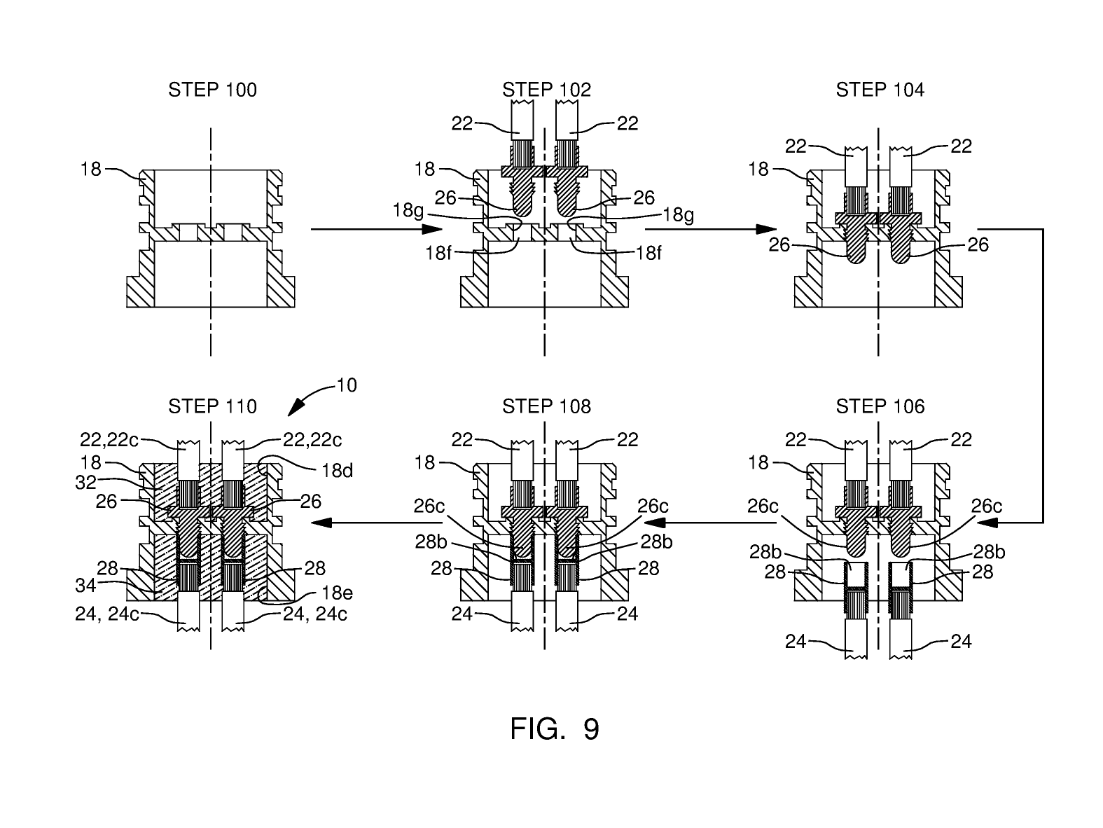

A process for forming pass-through cable connector assembly 10 will now be describe with particular reference to FIG. 9 which is a progression of steps in the forming of pass-through cable connector assembly 10. In a step 100, connector body 18 is provided, already formed with the features previously described. Next, in step 102 and step 104, first cables 22 with first terminal 26 already fixed thereto in electrical communication therewith are provided and first terminals 26 are urged under pressure into apertures 18f where barbs 26d plastically deform aperture walls 18g such that first cables 22 are positioned within first compartment 18d. Next, in step 106 and step 108, second terminals 28 with second cables 24 already fixed thereto in electrical communication therewith are joined with first terminals 26 using complementary mating features 26c, 28b such that second cables 24 are positioned within second compartment 18e. Finally, in step 110, first compartment 18d and second compartment 18e are filled with first potting material 32 and second potting material 34 respectively, where it should be understood that first potting material 32 and second potting material 34 may be applied simultaneously or sequentially. First potting material 32 encapsulates first terminal 26 within first compartment 18d and second potting material 34 encapsulates second terminal 28 within second compartment 18e.

Pass-through cable connector assembly 10 and the method described herein provide for superior sealing between first environment 14 and second environment 16 and also ensures accurate positioning of first cables 22, second cables 24, first terminals 26, and second terminals 28 by using connector body 18 which is preformed with apertures 18f which provide positioning of first cables 22, second cables 24, first terminals 26, and second terminals 28. Furthermore, since connector body 18 is preformed with apertures 18f, the number of first cables 22 and second cables 24 providing electrical communication through pass-through cable connector assembly 10 can be increased while minimizing the cross-sectional area of pass-through cable connector assembly 10.

While this invention has been described in terms of preferred embodiments thereof, it is not intended to be so limited, but rather only to the extent set forth in the claims that follow.

We claim:

1. A pass-through cable connector assembly comprising:
a connector body extending along an axis and formed of an electrically insulating material, said connector body having a peripheral wall which surrounds said axis and defines an interior of said connector body, said connector body also having a compartment wall which divides said interior into a first compartment and a second compartment, said compartment wall having an aperture extending therethrough from said first compartment to said second compartment, said aperture defining an aperture wall;
a first cable comprising an inner core made of an electrically conductive material, said first cable being located within said first compartment;
a first terminal formed of an electrically conductive material, said first terminal being located within said aperture and circumferentially contacting said aperture wall, said first terminal being joined to said inner core of said first cable such that said first terminal is in electrical communication with said inner core of said first cable;
a second cable comprising an inner core made of an electrically conductive material, said second cable being located within said second compartment; and
a second terminal formed of an electrically conductive material, said second terminal being joined to said inner core of said second cable such that said second terminal is in electrical communication with said inner core of said second cable;
wherein said first terminal and said second terminal have complementary mating features which mechanically lock said first terminal to said second terminal and which place said first terminal in electrical communication with said second terminal.

2. A pass-through cable connector assembly as in claim 1 wherein said first compartment includes a first potting material which circumferentially engages said peripheral wall and encapsulates said first terminal within said first compartment.

3. A pass-through cable connector assembly as in claim 2 wherein said second compartment includes a second potting material which circumferentially engages said peripheral wall and encapsulates said second terminal within said second compartment.

4. A pass-through cable connector assembly as in claim 3 wherein:
said first potting material circumferentially engages said first cable; and
said second potting material circumferentially engages said second cable.

5. A pass-through cable connector assembly as in claim 4 wherein:
said first cable further comprises an outer covering made of an electrically insulating covering which surrounds said inner core of said first cable;
said first potting material filling circumferentially engages said outer covering of said first cable;
said second cable further comprises an outer covering made of an electrically insulating covering which surrounds said inner core of said second cable; and
said second potting material circumferentially engages said outer covering of said second cable.

6. A pass-through cable connector assembly as in claim 2 wherein said first potting material circumferentially engages said first cable.

7. A pass-through cable connector assembly as in claim 1 wherein said first terminal includes a plurality of barbs which circumferentially engage said aperture wall.

8. A pass-through cable connector assembly as in claim 1 wherein said complementary mating features comprise a male feature of one of said first terminal and said second terminal and a female feature of the other of said one of said first terminal and said second terminal such that said male feature is located within said female feature in an interference fit relationship.

9. A pass-through cable connector assembly as in claim 1 wherein a portion of said first terminal is located within said second compartment.

10. A pass-through cable connector assembly as in claim 9 wherein said second terminal is located within said second compartment.

11. A pass-through cable connector assembly as in claim 9 wherein said second terminal is located entirely within said second compartment.

12. A pass-through cable connector assembly as in claim 1 wherein said second terminal is located within said second compartment.

13. A pass-through cable connector assembly as in claim 1 wherein electrical communication of said first terminal with said inner core of said first cable includes a first solder connection.

14. A pass-through cable connector assembly as in claim 13 wherein electrical communication of said second terminal with said inner core of said second cable includes a second solder connection.

15. A method of making a pass-through cable connector assembly, said method comprising:
providing a connector body which extends along an axis and is formed of an electrically insulating material, said connector body having a peripheral wall which surrounds said axis and defines an interior of said connector body, said connector body also having a compartment wall which divides said interior into a first compartment and a second compartment, said compartment wall having an aperture extending therethrough from said first compartment to said second compartment, said aperture defining an aperture wall;
providing a first cable comprising an inner core made of an electrically conductive material, said inner core of said first cable being joined to a first terminal made of an electrically conductive material such that said first terminal is in electrical communication with said inner core of said first cable;
positioning said first terminal within said aperture such that said first terminal circumferentially contacts said aperture wall and such that said first cable is located within said first compartment;
providing a second cable comprising an inner core made of an electrically conductive material, said inner core of said second cable being joined to a second terminal made of an electrically conductive material such that said second terminal is in electrical communication with said inner core of said second cable; and
joining said second terminal with said first terminal using complementary mating features which mechanically lock said first terminal to said second terminal and which place said first terminal in electrical communication with said second terminal, wherein said step of joining positions said second cable within said second compartment.
